(19) United States
(12) Patent Application Publication
(10) Pub. No.: US 2026/0234987 A1
(43) Pub. Date: Aug. 13, 2026

(54) FLUSH GARAGE DOOR PANELS AND METHOD OF CONSTRUCTION THEREOF

(71) Applicant: American Garage Door Factory, Inc, Bouse, AZ (US)

(72) Inventor: Robert A. Kelley, Bouse, AZ (US)

(73) Assignee: American Garage Door Factory, Inc., Bouse, AZ (US)

(21) Appl. No.: 19/048,704

(22) Filed: Feb. 7, 2025

(51) Int. Cl. E06B 3/48; E06B 3/70

(52) U.S. Cl. CPC E06B 3/485; E06B 3/70; E06B 2003/7044; E06B 2003/7051; E06B 2003/708

(57) ABSTRACT

Improved flush garage door panels and a method of constructing them are disclosed. The improved flush garage door panels have a flush roll-formed steel sheet; and a fluted polypropylene plastic sheet laminated to a flat inner surface of the flush roll-formed steel sheet. The end stiles are roll-formed so that they may be glued and metal clinched to the flush roll-formed steel sheet to provide a strong attachment and sound suppression. Each end stile also contains a block of EPS foam therein. Compared to currently used flush garage doors, the improved flush garage door panels use less materials, reduce oil canning, and provide more insulation and sound suppression.

### TECHNICAL FIELD

The present invention relates to the field of garage doors, and in particular, to improved flush garage door panels. The present invention also involves a method of constructing the improved flush garage door panels.

### BACKGROUND OF THE INVENTION

There has been a recent trend of using flush garage doors, which have no ribs, grooves, or embossing formed within them. Essentially, flush garage doors look like flat pieces of wood, with or without texture. There are a few models of flush garage door panels that are currently available. One type of flush garage door panel is a sandwich-style, which is constructed with three layers of material: a sheet of steel on the front skin, an insulation sheet in the middle, and a sheet of steel for the back skin. The three layers of materials in the sandwich-style flush garage door results in a significantly higher cost compared to other types of garage door models. A lower end uninsulated standard entry level model is also available. While it is less expensive than the three-layer sandwich-style flush garage door, it is not very popular because it is not insulated, because of its poor aesthetics, and because of its insufficient strength and support. A mid-level polyback flush garage door model offers insulation, but it also shares the same poor aesthetics of the uninsulated model.

Therefore, it would be desirable to provide improved flush garage door panels and a method of constructing them that overcome the problems described above.

### SUMMARY OF THE INVENTION

This summary is provided to introduce a selection of concepts in a simplified form that are further described below in the DETAILED DESCRIPTION OF THE INVENTION. This summary is not intended to identify key features of the claimed subject matter, nor is it intended to be used as an aid in determining the scope of the claimed subject matter.

In accordance with one embodiment of the present invention, an improved flush garage door panel is disclosed. The improved flush garage door panel comprises: a flush roll-formed steel sheet; and a fluted polypropylene plastic sheet laminated to a flat inner surface of the flush roll-formed steel sheet.

In accordance with another embodiment of the present invention, an improved flush garage door panel is disclosed. The improved flush garage door panel comprises a flush roll-formed steel sheet having a thickness of 0.016 to 0.028 inches. The flush roll-formed steel sheet comprises: a flat body; an elongated flange extending perpendicularly and rearwardly from a top section of the flat body; and an elongated channel extending perpendicularly and rearwardly from a bottom section of the flat body. The improved flush garage door panel also comprises a fluted polypropylene plastic sheet having a thickness of 3 to 4 millimeters; polyurethane moisture cure adhesive for laminating the fluted polypropylene plastic sheet to a flat inner surface of the flush roll-formed steel sheet; two end stiles glued to two opposing side edges of the flush roll-formed steel sheet and metal clinched to the elongated flange and the elongated channel of the flush roll-formed steel sheet; and at least one center stile glued to an inner surface of the fluted polypropylene plastic sheet and metal clinched to the elongated flange and the elongated channel of the flush roll-formed steel sheet.

In accordance with another embodiment of the present invention, a method for constructing an improved flush garage door panel is disclosed. The method of constructing the improved flush garage door panel comprises the steps of: creating a flush roll-formed steel sheet by: providing a flush steel sheet; roll-forming an elongated flange that extends perpendicularly and rearwardly from a top section of the flush steel sheet; and roll-forming an elongated channel that extends perpendicularly and rearwardly from a bottom section of the flush steel sheet. The method also comprises the steps of: providing a fluted polypropylene plastic sheet with a thickness of 3 to 4 millimeters; laminating the fluted polypropylene plastic sheet to a flat inner surface of the flush roll-formed steel sheet with polyurethane moisture cure adhesive; pressing the flush roll-formed steel sheet and fluted polypropylene plastic sheet together to remove any waves; glueing a first end stile to one side edge of the flush roll-formed steel sheet and metal clinching the first end stile to the elongated flange and the elongated channel of the flush roll-formed steel sheet; and glueing at least one center stile to an inner surface of the fluted polypropylene plastic sheet and metal clinching the at least one center stile to the elongated flange and the elongated channel of the flush roll-formed steel sheet; and glueing a second end stile to an opposing side edge of the flush roll-formed steel sheet and metal clinching the second end stile to the elongated flange and the elongated channel of the flush roll-formed steel sheet.

Further novel features and other objects of the present invention will become apparent from the following detailed description and discussion.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is side view of a prior art sandwich-style flush garage door panel;

FIG. 2 is a magnified partial side view of a fluted polypropylene plastic sheet and flush roll-formed steel sheet of an improved flush garage door panel of the present invention;

FIG. 3 is a perspective view of the fluted polypropylene plastic sheet of FIG. 2;

FIG. 4 is an exploded rear perspective view of the fluted polypropylene plastic sheet and flush roll-formed steel sheet of FIG. 2;

FIG. 5 is a rear perspective view of the fluted polypropylene plastic sheet and flush roll-formed steel sheet of FIG. 2, shown with the fluted polypropylene plastic sheet laminated to the flat inner surface of the flush roll-formed steel sheet;

FIG. 6 is an elevated rear perspective view of the fluted polypropylene plastic sheet and flush roll-formed steel sheet of FIG. 2, shown with the fluted polypropylene plastic sheet laminated to the flat inner surface of the flush roll-formed steel sheet;

FIG. 7 is a rear perspective view of a fully assembled flush garage door panel of the present invention with an end stile and a center stile coupled thereto;

FIG. 8 is a top view of an end stile of the present invention;

FIG. 9 is an elevated exploded partial front perspective view of the flush roll-formed steel sheet and an end stile;

FIG. 10 is an elevated partial front perspective view of the flush roll-formed steel sheet and end stile of FIG. 9, shown coupled together; and

FIG. 11 is a flow diagram of a method for constructing the improved flush garage door panels of the present invention.

### DETAILED DESCRIPTION OF THE INVENTION

The description set forth below is intended as a description of presently preferred embodiments of the disclosure and is not intended to represent the only forms in which the present disclosure can be constructed and/or utilized. The description sets forth the functions and the sequence of steps for constructing and operating the disclosure. It is to be understood, however, that the same or equivalent functions and sequences can be accomplished by different embodiments that are also intended to be encompassed within the spirit and scope of this disclosure.

Earlier embodiments of flush garage door panels exist. One type of flush garage door panel is an uninsulated flush garage door, which is not very popular. Because a flush garage door panel has no ribs, grooves, or embossment to provide any strength or rigid feel to it, an uninsulated flush garage door is simply a flat sheet of thin steel. One reason for its lack of popularity is because of the excessive oil canning or waves that are visible on the front of the door. Oil canning is a cosmetic issue experienced with sheet metal products. It causes the metal garage door to appear wavy or distorted. Another problem associated with uninsulated flush garage doors is their lack of strength and support. With no ribbing, grooves, or embossments, the only support that they have are the brace/support stiles that the door hinges attach to. This is the reason why the uninsulated flush garage doors have excessive oil canning plus waves/wrinkles across the face of the door.

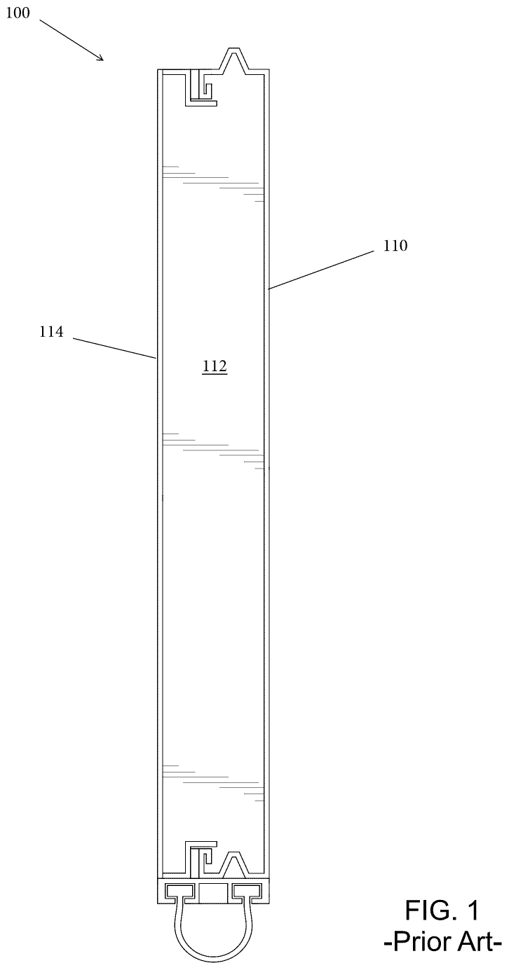

Another type of flush garage door panel 100 has a steel back sandwich-type of construction: having a sheet of steel on the front skin 110, an insulation sheet 112 in the middle, and a sheet of steel for the back skin 114. This sandwich-type flush garage door panel 100 is shown in FIG. 1. These sandwich-type flush garage door panels 100 are of higher cost compared to other types of flush garage door models because they require more materials and extra processes to make them. The extra materials and processes eliminate the problem of oil canning, but also contribute to their higher price.

Another type of flush garage door is a polyback flush garage door. A polyback flush garage door is steel garage door with a layer of insulation on the inside. A polyback flush garage door is considered to be midlevel as it is more expensive than an uninsulated flush garage door, but less expensive than a steel back sandwich-type flush garage door 100. Polyback flush garage doors begin their life as uninsulated flush garage door models that are post insulated after the door is manufactured. They are insulated with pre-laminated sheets of expanded polystyrene (EPS). These EPS sheets have a very thin hair cell vinyl backing laminated on top of EPS foam sheets. This post insulating helps reduce the number of oil canning waves and wrinkles, but the waves and wrinkles themselves are more visible and pronounced. If one were to push on the face of the steel sheet, it would move in and out and create a popping or pinging sound, similar to the sounds of an oil can.

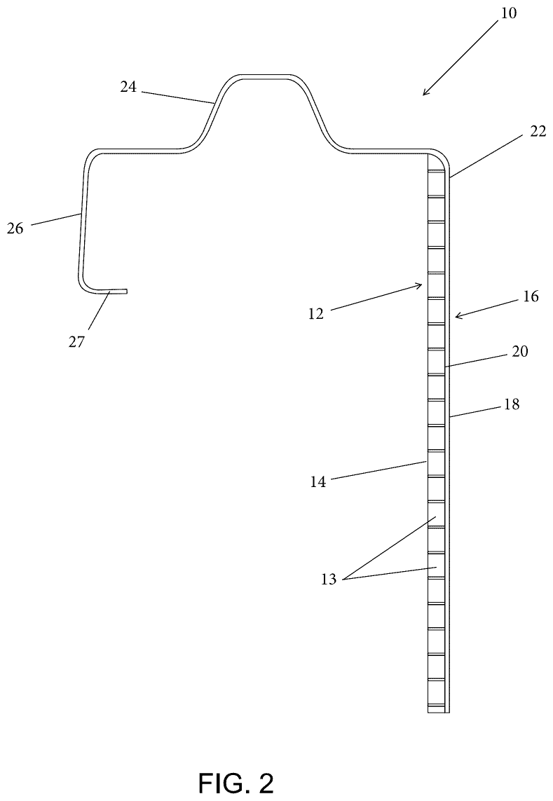

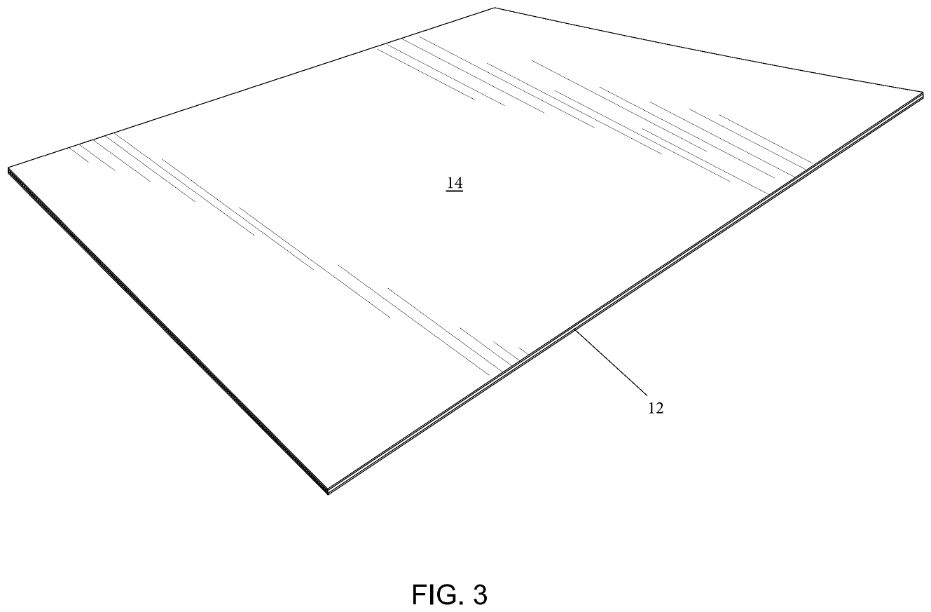

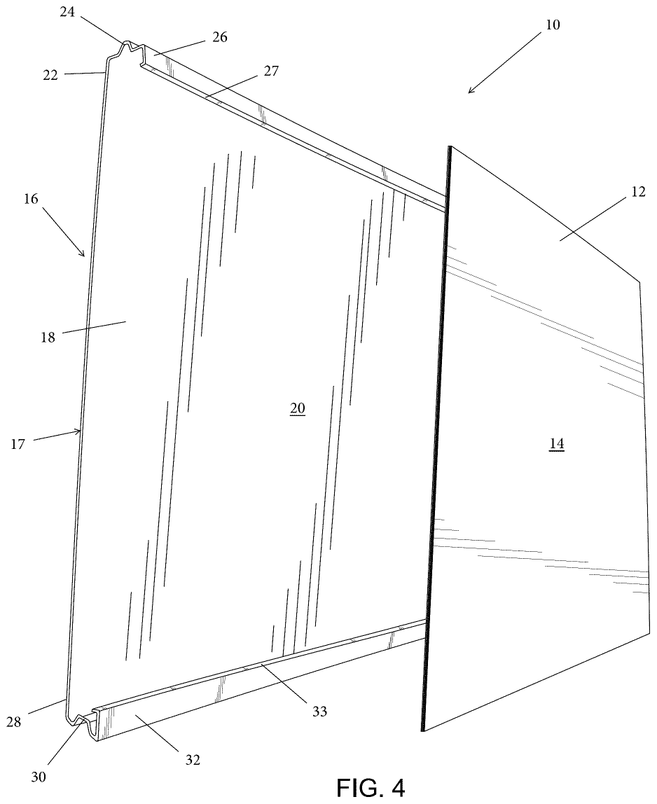

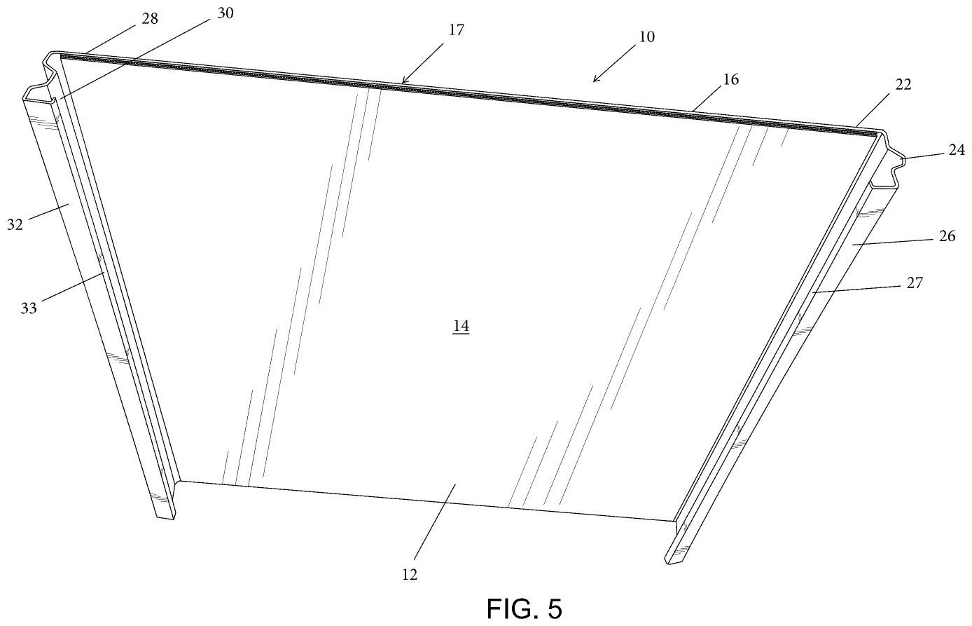

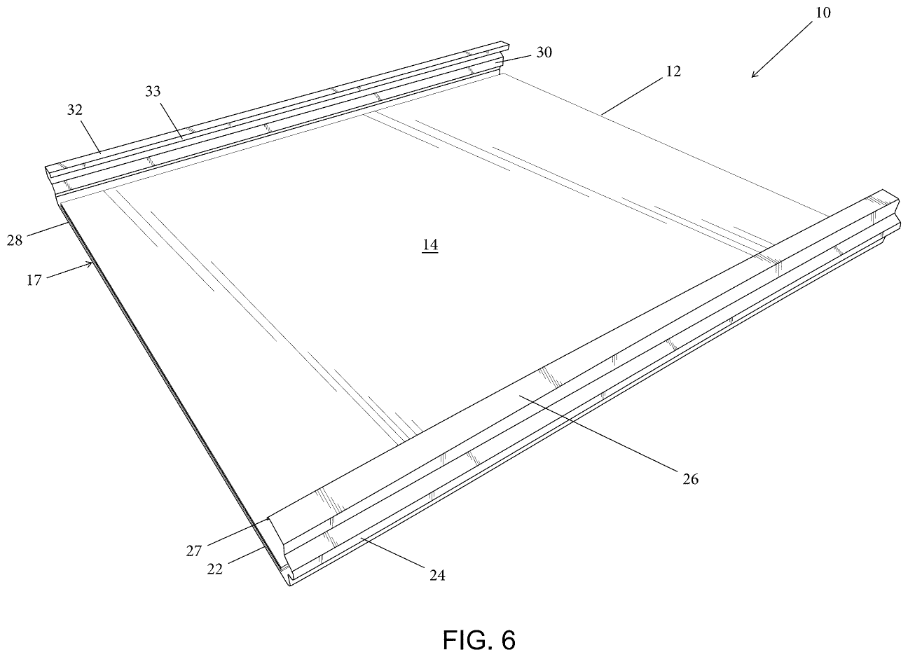

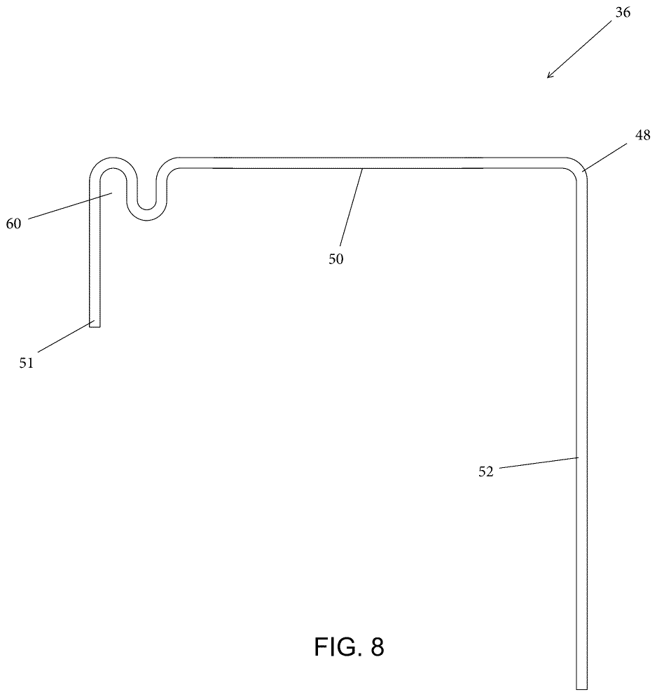

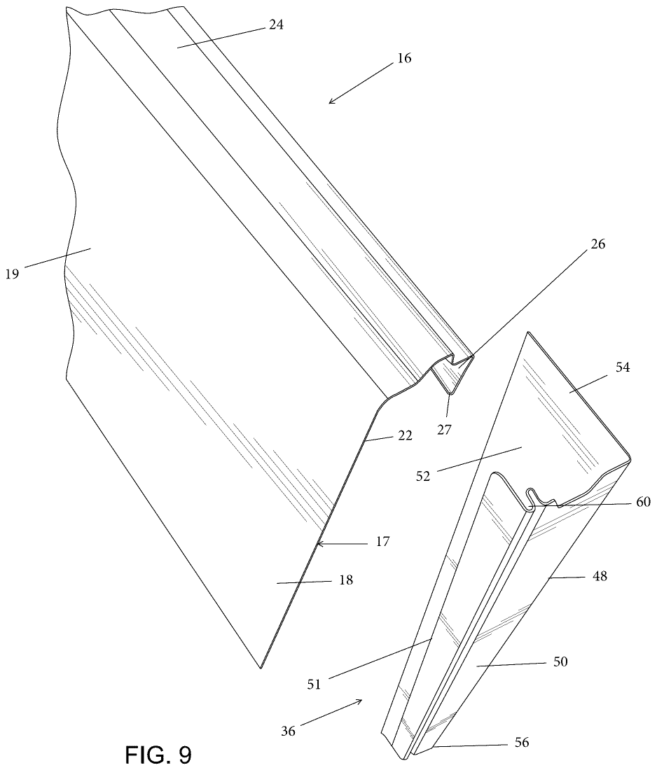

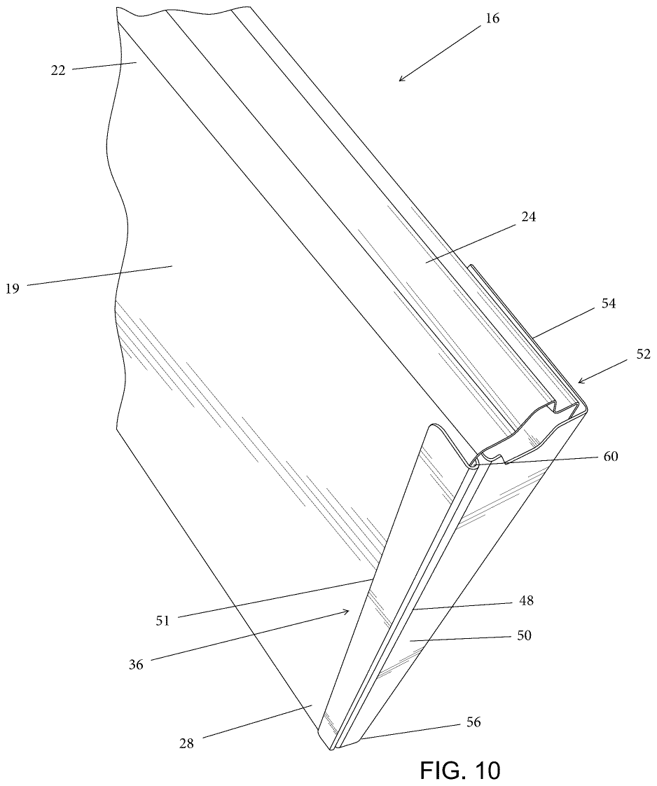

FIGS. 2-10 together show the improved flush garage door panels 10 of the present invention. The flush garage door panels 10 have a fluted polypropylene plastic sheet 12 that is laminated to a flat inner surface 20 of the flat body 18 of a flush roll-formed steel sheet 16. The fluted polypropylene plastic sheet 12 defines a plurality of flutes/spaces 13 therein (see FIG. 2). The length and height of the fluted polypropylene plastic sheet 12 is equal to the length and height of the flat inner surface 20 of the flat body 18 of the flush roll-formed steel sheet 16. The fluted polypropylene plastic sheet 12 may be white in color, but any suitable color will be sufficient. The fluted polypropylene plastic sheet 12 is laminated and bonded with a high heat high strength polyurethane (PUR) moisture cure adhesive. The fluted polypropylene plastic sheet 12 may have a thickness of between 3-4 millimeters. While this is the preferred thickness, substantial benefit may still be obtained from a fluted polypropylene plastic sheet 12 being slightly thicker or thinner than between 3-4 millimeters.

The flush roll-formed steel sheet 16 may have a height of 18 inches, 21 inches, 24 inches, or any other suitable height. The flush roll-formed steel sheet 16 may have a thickness of between 0.016-0.028 inches. While this is the preferred thickness, substantial benefit may still be obtained from a flush roll-formed steel sheet 16 being slightly thicker or thinner than between 0.0185-0.028 inches.

The flush roll-formed steel sheet 16 has a flat outer surface 21 and a flat inner surface 20. The garage door panels 10 herein are flush; i.e. they have no ribs, grooves, or indentations formed on the flat outer surface 19. The flat outer surface 19 may have a woodgrain texture (not shown) to look like flat pieces of wood or the flat outer surface 19 may not have any texture. The flush roll-formed steel sheet 16 also has an elongated flange/tongue 24 formed at its top section 22 and has an elongated channel/groove 30 formed at its bottom section 28. The elongated flange 24 extends perpendicularly and rearwardly from the top section 22 of the flat body 18 of the flush roll-formed steel sheet 16. Similarly, the elongated channel 30 extends perpendicularly and rearwardly from the bottom section 28 of the flat body 18 of the flush roll-formed steel sheet 16. When the flush garage door panels 10 are assembled to construct the flush garage door, the elongated channel 30 of one flush roll-formed steel sheet 16 is configured to receive therein the elongated flange 24 of another flush roll-formed steel sheet 16 positioned below it, thereby forming a tongue and groove connection between them. While the elongated flange 24 is described as being formed at the top section 22 and the elongated channel 30 is described as being formed at the bottom section 28 of the flush roll-formed steel sheet 16, it should be clearly understood that substantial benefit may also be derived from the elongated channel 30 being formed at the top section 22 and the elongated flange 24 being formed at the bottom section 28 of the flush roll-formed steel sheet 16.

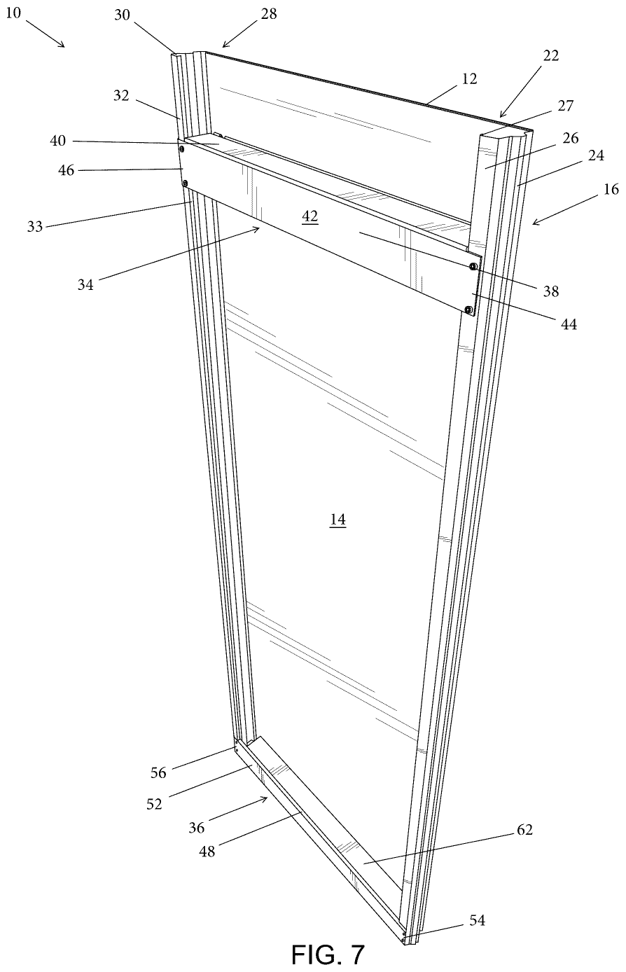

Referring to FIGS. 7-10, a completed flush garage door panel 10 also has two end stiles 36 and at least one center stile 34. The number of center stiles 34 is determined by the length of the flush garage door panel 10; e.g. an eight-foot-long flush garage door panel 10 would typically have one center brace stile 34 while a sixteen-foot-long flush garage door panel 10 section would typically have three center brace stiles 34.

The center stile(s) 34 has an elongated L-shaped body 38. The elongated L-shaped body 38 of a center stile 34 is made up of a side wall 40 and a rear wall 42 that are contiguous with each other and are positioned at a 90° angle (perpendicular) to each other. The side wall 40 of the elongated L-shaped body 38 of the center stile 34 is shorter than the rear wall 42 of the elongated L-shaped body 38 of the center stile 34. The side wall 40 of the elongated L-shaped body 38 of the center stile 34 is configured to fit snugly between the end edge 27 of the inner end wall 26 of the elongated flange 24 at the top section 22 of the flush roll-formed steel sheet 16 and the end edge 33 of the inner end wall 32 of the elongated channel 30 at the bottom section 28 of the flush roll-formed steel sheet 16. The rear wall 42 of the elongated L-shaped body 38 of the center stile 34 is longer than the side wall 40 of the elongated L-shaped body 38 of the center stile 34. A first end 44 of the rear wall 42 is configured to overlap the inner end wall 26 of the elongated flange 24 formed at the top section 22 of the flush roll-formed steel sheet 16. A second end 46 of the rear wall 42 is configured to overlap an inner end wall 32 of the elongated channel 30 formed at the bottom section 28 of the flush roll-formed steel sheet 16.

The center stile(s) 34 is attached to an inner surface 14 of the fluted polypropylene plastic sheet 12 with urethane adhesive glue. The urethane adhesive glue is thicker and more viscous than the PUR hot melt moisture cure glue that is used to laminate the fluted polypropylene plastic sheet 12 to the flat inner surface 20 of the flat body 18 of the flush roll-formed steel sheet 16. When the urethane glue is dry it retains more body/volume in the bond joint area thus adding cushion and a muffler effect, similar to a shock absorber. The urethane adhesive glue is applied to the portion(s) of the inner surface 14 of the fluted polypropylene plastic sheet 12 where the center stile(s) 34 will be attached. The length of the flush garage door panel 10 determines the number of center stiles 34 that will be coupled to the inner surface 14 of the fluted polypropylene plastic sheet 12. After urethane adhesive glue has been applied to the portion(s) of the inner surface 14 of the fluted polypropylene plastic sheet 12 where a center stile 34 will be placed, the side wall 40 of the elongated L-shaped body 38 of the center stile 34 is glued to the inner surface 14 of the fluted polypropylene plastic sheet 12 that has been previously laminated onto the flat inner surface 20 of the flat body 18 of the laminated flush roll-formed steel sheet 16. The first end 44 of the rear wall 42 of the center stile 34 is then metal clinched to the inner end wall 26 of the elongated flange 24 of the top section 22 of the laminated flush roll-formed steel sheet 16 and the second end 46 of the rear wall 42 of the center stile 34 is then metal clinched to the inner end wall 32 of the elongated channel 30 of the bottom section 28 of the laminated flush roll-formed steel sheet 16. The center stile 34 is metal clinched to the laminated flush roll-formed steel sheet 16 for permanent attachment.

Each end stile has an elongated L-shaped body 36. The elongated L-shaped body 48 of the end stile 36 is made up of a side wall 50 and a rear wall 52 that are contiguous with each other and are positioned at a 90° angle (perpendicular) to each other. The side wall 50 is configured to wrap around and cover one of the side ends of the flush garage door panel 10. The side wall 50 of the L-shaped body 48 of the end stile 36 and the rear wall of the end stile 36 are equal in length. The length of the rear wall 52 of the elongated L-shaped body 48 of the end stile 36 is also equal to the length of the rear wall 42 of the elongated L-shaped body 38 of the center stile 34. A first end 54 of the rear wall 52 is configured to overlap the inner end wall 26 of the elongated flange 24 formed at the top section 22 of the flush roll-formed steel sheet 16. A second end 56 of the rear wall 52 is configured to overlap the inner end wall 32 of the elongated channel 30 formed at the bottom section 28 of the flush roll-formed steel sheet 16.

The elongated L-shaped body 48 of each of the end stiles 36 has an elongated groove 60. The elongated groove 60 and the side wall 50 of the L-shaped body 48 of the end stile 36 are contiguous with each other and are positioned at a 90° angle (perpendicular) to each other. Thus, the elongated groove 60 is positioned parallel to the rear wall 52 of the elongated L-shaped body 48 of the end stile 36. The elongated groove 60 is formed by roll-forming an end edge 51 of the side wall 50 of the elongated L-shaped body 48 of the end stile 36 back onto itself. The elongated groove 60 therefore has a length equal to the side wall 50 of the elongated L-shaped body 48 of the end stile 36. The elongated groove 60 is configured to receive urethane adhesive glue and the side edge 17 of the flat body 18 of the laminated flush roll-formed steel sheet 16 therein. The elongated groove 60 allows each end stile 36 to be glued to one of the opposing side edges 17 of the flat body 18 of the laminated flush roll-formed steel sheet 16 for strength and quiet operation. The overlapping first end 54 of the rear wall 52 of each end stile 36 is also metal clinched to the inner end wall 26 of the elongated flange 24 at the top section 22 of the flush roll-formed steel sheet 16. Similarly, the overlapping second end 56 of the rear wall 52 of each end stile 36 is then also metal clinched to the inner end wall 32 of the elongated channel 30 at the bottom section 28 of the flush roll-formed steel sheet 16.

A 1.5-pound density rectangular block of EPS foam 62 is housed within the elongated L-shaped body 48 of each end stile 36. While 1.5-pound density is preferred, it should be clearly understood that substantial benefit may still be derived from a block of EPS foam 62 being slightly higher or lower than 1.5-pound density. The EPS foam block 62 is configured to fit snugly between the end edge 27 of the inner end wall 26 of the elongated flange 24 at the top section 22 of the flush roll-formed steel sheet and the end edge 33 of the inner end wall 32 of the elongated channel 30 at the bottom section 28 of the flush roll-formed steel sheet 16. The EPS foam block 62 of the end stile 36 is the same length as the side wall 40 of the elongated L-shaped body 38 of the center stile 34. The EPS foam block 62 may be coupled to the inner surface 14 of the fluted polypropylene plastic sheet 12 with urethane adhesive glue. The rectangular block of EPS foam block 62 within the elongated L-shaped body 48 of each end stile 36 improves the strength and quiet operation of the flush roll-formed garage door panel 10. Although the EPS foam block 62 is described as being housed within the elongated L-shaped body 48 of each end stile 36, substantial benefit may still be derived from an EPS foam block 62 being housed within the elongated L-shaped body 38 of at least one center stile 34.

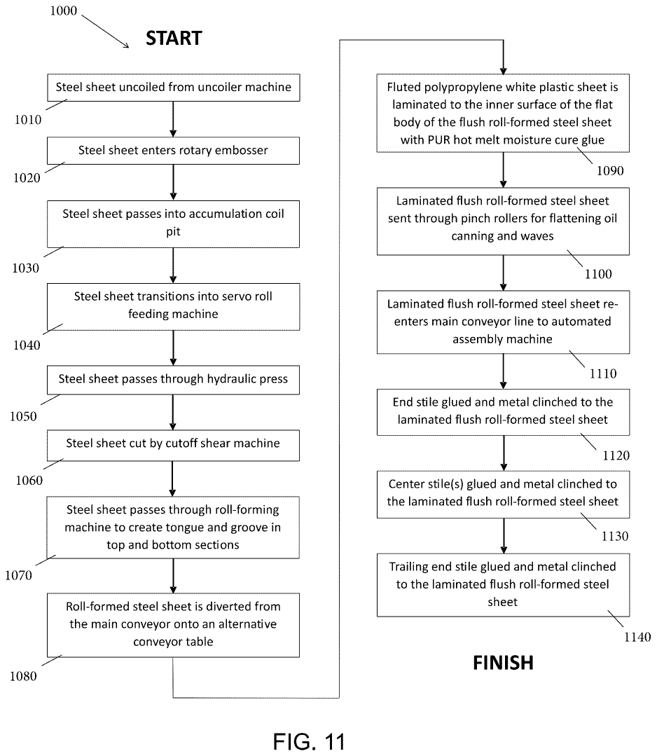

FIG. 11 is a flow chart illustrating an embodiment of a method 1000 for constructing the flush garage door panels of the present invention. At step 1010, a steel coil is provided and is uncoiled from an uncoiler machine. From the uncoiler machine, at step 1020 a steel sheet may enter a rotary embossing machine to apply a woodgrain texture onto the smooth pre-painted steel sheet. Alternatively, if the finished flush garage door panel 10 is to have a smooth outer surface 19, the pre-painted steel sheet will pass over the top of the rotary embosser to bypass the embossing process.

After either entering the embossing machine to apply a woodgrain texture or bypassing the embossing process to achieve a smooth outer surface 19, the pre-painted steel sheet at step 1030 drops down into an accumulation coil pit to take up slack from the rapidly moving steel coil. Coming up from out of the coil pit, at step 1040 the steel sheet transitions into the servo roll feeding machine. At step 1050, the roll feeding machine pulls and pushes the steel sheet into and through a hydraulic press. Typically, a steel sheet would be stamped in the hydraulic press with a raised panel design. However, because of the flush design of the garage door panels 10 of the present invention, the steel sheet will pass through the hydraulic press without stopping and without being stamped into a raised panel design.

After exiting and passing through the hydraulic press without being stamped, the steel sheet then passes through the cutoff shear machine and then onto a long runout guided table. When the steel sheet reaches its correct programmed length, at step 1060 the cutoff shear machine cuts the steel sheet as it is paused by the roll-feed station that controls the forward movement of the steel sheet.

After the steel sheet is cut by the cutoff shear machine, the conveyer runout table engages powered rolls that push the steel sheet into the roll-forming machine. At step 1070 the roll-forming machine rolls or bends the top section of the steel sheet to create an elongated flange/tongue 24 that runs along the length of the top section 22 of the steel sheet 16. The roll-forming machine also rolls or bends the bottom section of the steel sheet to create an elongated channel/groove 30 that runs along the length of the bottom section 28 of the steel sheet 16. The elongated channels 30 and elongated flanges 24 create tongue and groove type connections between the flush garage door panels 10; i.e. the elongated flange 24 of a given flush garage door panel 10 mates with the elongated channel 30 of a first adjacent flush garage door panel 10 (positioned above it) while the same given flush garage door panel's 10 elongated channel 30 mates with the elongated flange 24 of a second adjacent flush garage door panel 10 (positioned below it). While the elongate flange 24 is described as being formed at the top section 22 of the flush roll-formed steel sheet 16 and the elongated channel 30 is described as being formed at the bottom section 28 of the flush roll-formed steel sheet 16, it should be clearly understood that substantial benefit may also be derived from the elongated channel 30 being formed at the top section 22 and the elongated flange 24 being formed at the bottom section 28.

Upon exiting the roll-forming machine, the once flat steel sheet has now been configured into a flush roll-formed steel sheet 16 with an elongated channel 30 and an elongated flange 24 formed at its opposing bottom section 28 and top section 22, respectively. Typically, a traditional garage door panel would pass from the roll-forming machine, down a conveyor, and into an automated assembly machine for installation of center and end brace stiles. However, at step 1080 the flush roll-formed steel sheet 16 of the present invention, is slid off or diverted from the conveyor that would normally lead it into the automated final assembly machine and is instead placed on an alternative conveyor table.

At step 1090 on the alternative conveyor table, the flat inner surface 20 of the flat body 18 of the flush roll-formed steel sheet 16 is coated with a PUR hot melt moisture cure adhesive. The PUR hot melt moisture cure adhesive is also applied to one side of the fluted polypropylene plastic sheet 12. One or more fluted polypropylene plastic sheets 12 may be used, depending on the size of the flush garage door panel 10. The side of the fluted polypropylene plastic sheet 12 with the PUR hot melt moisture cure adhesive is then placed onto the flat inner surface 20 of the flat body 18 of the flush foll-formed steel sheet 16 that is coated with PUR holt melt moisture cure adhesive. The fluted polypropylene plastic sheet 12 is only laminated to the flat inner surface 20 of the flat body 18 of a flush roll-formed steel sheet 16; i.e. the fluted polypropylene plastic sheet 12 is not present within the elongated flange 34 or the elongated channel 30.

At step 1100 the flush roll-formed steel sheet 16 with the fluted polypropylene plastic sheet 12 adhered to it, are now sent through a series of pinch rollers. The pinch rollers will push out and flatten any oil canning/waves in the laminated flush roll-formed steel sheet 16 before and during the PUR hot melt moisture cure adhesive curing process. As the PUR hot melt moisture cure adhesive develops its green strength or handling strength, the oil canning/waves are pushed and flattened out. Now, upon exiting the alternative conveyor table, the laminated flush roll-formed steel sheet 16 has a more rigid and solid feel to it and the oil canning/waves have been eliminated. From here, the laminated flush roll-formed steel sheet 16 is ready to continue down the roll-form machine's exiting conveyor line and into the automated assembly machine. At step 1110 the laminated flush roll-formed steel sheet 16 is placed back onto the conveyor table on the main conveyor line so that it will enter the automated assembly machine.

At the first stop, at step 1120 the automated assembly machine installs the first end stile 36 onto the end of the flat inner surface 20 of the flat body 18 of the laminated flush roll-formed steel sheet 16. All end stiles 36 have urethane adhesive glue applied on them automatically while they travel to be placed by the assembly arm of the machine. The urethane adhesive glue is applied directly within the elongated groove 60 of the elongated L-shaped body 48 of the end stile 36. The end of the flat body 18 of the laminated flush roll-formed steel sheet 16 is then inserted into the elongated groove 60. The elongated groove 60 allows each end stile 36 to be glued to one of the opposing side edges 17 of the flat body 18 of the laminated flush roll-formed steel sheet 16 for strength and quiet operation. The glue helps to muffle sound and vibration of the flush garage door panel 10. The overlapping first end 54 of the rear wall 52 of each end stile 36 is also metal clinched to the inner end wall 26 of the elongated flange 24 at the top section 22 of the flush roll-formed garage door panel 10. Similarly, the overlapping second end 56 of the rear wall 52 of each end stile 36 is then also metal clinched to the inner end wall 32 of the elongated channel 30 at the bottom section 28 of the flush roll-formed garage door panel 10. The rear wall 52 of the end stile 36 is metal clinched to the inner end wall 26 of the elongated flange 24 at the top section 22 of the flush roll-formed garage door panel 10 and to the inner end wall 32 of the elongated channel 30 at the bottom section 28 of the laminated flush roll-formed steel sheet 16 for permanent attachment.

As the laminated flush roll-formed steel sheet 16 automatically moves on the conveyor toward to step 1130 of installing a center brace stile 34, urethane adhesive glue is applied to the portion(s) of the inner surface 14 of the fluted polypropylene sheet 12 where the center stile(s) 34 will be attached. The length of the flush garage door panel 10 determines the number of center stiles 34 that will be coupled to the laminated flush roll-formed steel sheet 16. As an example, an eight-foot-long flush garage door panel 10 would have one center brace stile 34 while a sixteen-foot-long flush garage door panel section 10 would have three center brace stiles 34. After urethane adhesive glue has been applied to the portion(s) of the inner surface 14 of the fluted polypropylene sheet 12 where a center stile 34 will be placed, the side wall 40 of the elongated L-shaped body 38 of the center stile 34 is glued to the fluted polypropylene sheet 12 that has been previously laminated onto the flat inner surface 20 of the flat body 18 of the laminated flush roll-formed steel sheet 16. The first end 44 of the rear wall 42 of the center stile 34 is then metal clinched to the inner end wall 26 of the elongated flange 24 of the top section 22 of the laminated flush roll-formed steel sheet 16 and the second end 46 of the rear wall 42 of the center stile 34 is then metal clinched to the inner end wall 32 of the elongated channel 30 of the bottom section 28 of the laminated flush roll-formed steel sheet 16. The center stile 34 is metal clinched to the laminated flush roll-formed steel sheet 16 for permanent attachment. This process is repeated for any additional center stiles 34 on the flush garage door panel 10.

After the center stile(s) 34 have been attached, the laminated flush roll-formed steel sheet 16 moves on through the conveyor line to have the trailing end stile attached at step 1140. Urethane adhesive glue is inserted into the elongated groove 60 of the elongated L-shaped body 48 of the trailing end stile 36 and the trailing end stile 36 is glued to end of the flat inner surface 20 of the flat body 18 of the laminated flush roll-formed steel sheet 16 in a similar fashion as the first end stile 36 described above. The trailing end stile 36 is then metal clinched to the inner end wall 26 of the elongated flange 24 of the top section 22 of the laminated flush roll-formed steel sheet 16 and to the inner end wall 32 of the elongated channel 30 of the bottom section 28 of the laminated flush roll-formed steel sheet 16. The finished flush garage door panel 10 now exits the automated assembly machine.

The uninsulated flush garage door panels that are currently being used are simply flat sheets of thin steel that do not have any noise suppression features, so they rattle, pop, ping, and amplify sound. The improved flush garage door panels 10 of the present invention provide noise suppression by: 1) laminating fluted polypropylene 12 to the flat inner surface 20 of the flat body 18 of the flush roll-formed steel sheet 16; and 2) using a coat of PUR hot melt glue to bond the fluted polypropylene plastic sheet 12 to the flat inner surface 20 of the flat body 18 of the flush roll-formed steel sheet 16. These two features together provide a sound deadening semi rigid flush garage door panel 10. The sound is absorbed by the fluted polypropylene plastic sheet 12, which traps air in the spaces/flutes 13 of the fluted polypropylene plastic sheet 12. This trapping of air in between the flutes not only aids in sound suppression, but this also helps to improve heat and cold resistance by providing the flush garage door panel 10 with a small R-value of between 1 and 2. R-value is a measure of insulation's ability to resist heat traveling through it, where the higher the R-value, the better the thermal performance of the insulation. A plain uninsulated flush garage door panel has zero R-value and thus acts as a heat/cold transfer sheet rather than an insulator.

The sandwich-style flush garage door panels 100 that are currently being used are much heavier than the flush garage door panels 10 of the present invention because of the two layers of steel 110, 114 and the 2-inch-thick insulation 112 in between them. The lighter flush garage door panels 10 of the present invention are able to use smaller springs and a lighter reinforcement track than those required for a sandwich-style flush garage door panel 100. For example, the flush garage door panels 10 of the present invention may be used with a 42-inch angle reinforcement track, while the sandwich-style flush garage door panels 100 or the polyback insulated flush garage door panels would need to use a much heavier/expensive 65-inch or 82-inch angle reinforcement track. The smaller springs and a lighter reinforcement track require less material and therefore cost less. The thickness of the flush garage door panel 10 (flush roll-formed steel sheet+fluted polypropylene plastic sheet) is less than half of the 2-inch thickness of the sandwich-type flush garage door panels 100 (front skin steel+2-inch insulation+back skin steel). Therefore, the inside retainer frame of any windows that may be used with the flush garage door panels 10 will also have less than half of the thickness of the inside retainer frame of a window that would need to be used on the sandwich-style flush garage door panel 100 or a polyback insulated flush garage door model.

The present invention provides additional sound suppression by the use of glue adhesive on the end stiles and the center stile(s). Other flush garage door panels only use glue on the center stile and only use metal fasteners on their die and stamped end stiles. The improved flush garage door panels of the present invention are not die and stamped; rather, they use roll-formed end stiles 36 that have an elongated groove 60. The die and stamped end stiles that have been traditionally used do not have any such groove. Instead, they use a metal clinch joint to clinch the end stile to the end of the front skin steel 110. If glue were to be applied to the die and stamped end stiles that lack such a groove, the glue would clog and gum up the dies in the metal clinching tool. In the present invention, urethane adhesive glue is applied into these elongated grooves 60 and then the end stiles 36 are adhered to the end of the flat inner surface 20 of the flat body 18 of the laminated flush roll-formed steel sheet 16 prior to the automated assembly process. The typical stamped end stiles have no grooves within them to hold any glue and therefore do not use glue on the end stiles of the current flush garage door panels. The glue adhesive on the end stiles 36 of the improved flush garage door panels 10 of the present invention helps to improve the quiet operation of the flush garage door panels 10. The layer of glue/adhesive between the center brace stile 34 and the laminated fluted polypropylene sheet 12 provides additional sound suppression to prevent sound vibration and to ensure quiet operation of the garage door.

The present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

What is claimed is:

1. A flush garage door panel comprising:
a flush roll-formed steel sheet; and
a fluted polypropylene plastic sheet laminated to a flat inner surface of the flush roll-formed steel sheet.

2. The flush garage door panel of claim 1, wherein the flush roll-formed steel sheet comprises:
a flat body;
an elongated flange formed at a top section of the flat body; and
an elongated channel formed at a bottom section of the flat body.

3. The flush garage door panel of claim 1, wherein the elongated flange extends perpendicularly and rearwardly from the top section of the flat body.

4. The flush garage door panel of claim 1, wherein the elongated channel extends perpendicularly and rearwardly from the bottom section of the flat body.

5. The flush garage door panel of claim 1, wherein the flush roll-formed steel sheet has a thickness of 0.016 to 0.028 inches.

6. The flush garage door panel of claim 1, wherein the fluted polypropylene plastic sheet has a thickness of 3 to 4 millimeters.

7. The flush garage door panel of claim 1, further comprising polyurethane moisture cure adhesive for laminating the fluted polypropylene plastic sheet to the flat inner surface of the flush roll-formed steel sheet.

8. The flush garage door panel of claim 2, further comprising:
at least one center stile coupled to an inner surface of the fluted polypropylene plastic sheet; and
two end stiles, each end stile coupled to one of two opposing side edges of the flush roll-formed steel sheet.

9. The flush garage door panel of claim 8, wherein the at least one center stile has an L-shaped body, the L-shaped body comprising:
a rear wall; and
a side wall being contiguous with the rear wall and being configured to fit snugly between the top section and the bottom section of the flush roll-formed steel sheet.

10. The flush garage door panel of claim 9, wherein the rear wall comprises:
a first end that is coupled to an inner end wall of the elongated flange formed at the top section of the flat body of the flush roll-formed steel sheet; and
a second end that is coupled to an inner end wall of the elongated channel formed at the bottom section of the flat body of the flush roll-formed steel sheet.

11. The flush garage door panel of claim 10, wherein the first end of the rear wall is metal clinched to the inner end wall of the elongated flange formed at the top section of the flat body of the flush roll-formed steel sheet and wherein the second end of the rear wall is metal clinched to the inner end wall of the elongated channel formed at the bottom section of the flat body of the flush roll-formed steel sheet.

12. The flush garage door panel of claim 8, wherein the two end stiles each has an L-shaped body, the L-shaped body comprising:
a rear all; and
a side wall being contiguous with the rear wall and being configured to wrap around and cover one of the two side edges of the flush roll-formed steel sheet.

13. The flush garage door panel of claim 12, wherein the rear wall comprises:
a first end that is coupled to an inner end wall of the elongated flange formed at the top section of the flat body of the flush roll-formed steel sheet; and
a second end that is coupled to an inner end wall of the elongated channel formed at the bottom section of the flat body of the flush roll-formed steel sheet.

14. The flush garage door panel of claim 13, wherein the first end of the rear wall is metal clinched to the inner end wall of the elongated flange formed at the top section of the flat body of the flush roll-formed steel sheet and wherein the second end of the rear wall is metal clinched to the inner end wall of the elongated channel formed at the bottom section of the flat body of the flush roll-formed steel sheet.

15. The flush garage door panel of claim 12, wherein each of the two end stiles further comprises an elongated groove, the elongated groove being contiguous with the side wall of the L-shaped body and being positioned perpendicular to the side wall.

16. The flush garage door panel of claim 15, wherein the elongated groove is configured to receive glue adhesive and one of the two side edges of the flush roll-formed steel sheet.

17. The flush garage door panel of claim 12, further comprising a rectangular block of EPS foam housed within the elongated L-shaped body and coupled to the inner surface of the fluted polypropylene plastic sheet.

18. A flush garage door panel comprising:
a flush roll-formed steel sheet having a thickness of 0.016 to 0.028 inches, the flush roll-formed steel sheet comprising:
a flat body;
an elongated flange extending perpendicularly and rearwardly from a top section of the flat body; and
an elongated channel extending perpendicularly and rearwardly from a bottom section of the flat body;
a fluted polypropylene plastic sheet having a thickness of 3 to 4 millimeters;
polyurethane moisture cure adhesive for laminating the fluted polypropylene plastic sheet to a flat inner surface of the flush roll-formed steel sheet;
two end stiles glued to two opposing side edges of the flush roll-formed steel sheet and metal clinched to the elongated flange and the elongated channel of the flush roll-formed steel sheet; and
at least one center stile glued to an inner surface of the fluted polypropylene plastic sheet and metal clinched to the elongated flange and the elongated channel of the flush roll-formed steel sheet.

19. The flush garage door panel of claim 18, wherein each of the two end stiles has an L-shaped body comprising:
a rear wall;
a side wall being contiguous with the rear wall and being configured to wrap around and cover one of the two side edges of the flush roll-formed steel sheet;
an elongated groove, the elongated groove being contiguous with the side wall of the L-shaped body and being positioned perpendicular to the side wall and wherein the elongated groove is configured to receive glue adhesive and one of the two side edges of the flush roll-formed steel sheet; and
a rectangular block of EPS foam housed within the elongated L-shaped body and coupled to the inner surface of the fluted polypropylene plastic sheet.

20. A method of constructing a flush garage door panel comprising the steps of:
creating a flush roll-formed steel sheet by:
providing a flush steel sheet;
roll-forming an elongated flange that extends perpendicularly and rearwardly from a top section of the flush steel sheet; and
roll-forming an elongated channel that extends perpendicularly and rearwardly from a bottom section of the flush steel sheet;
providing a fluted polypropylene plastic sheet with a thickness of 3 to 4 millimeters;
laminating the fluted polypropylene plastic sheet to a flat inner surface of the flush roll-formed steel sheet with polyurethane moisture cure adhesive;
pressing the flush roll-formed steel sheet and fluted polypropylene plastic sheet together to remove any waves;
glueing a first end stile to one side edge of the flush roll-formed steel sheet and metal clinching the first end stile to the elongated flange and the elongated channel of the flush roll-formed steel sheet; and
glueing at least one center stile to an inner surface of the fluted polypropylene plastic sheet and metal clinching the at least one center stile to the elongated flange and the elongated channel of the flush roll-formed steel sheet; and
glueing a second end stile to an opposing side edge of the flush roll-formed steel sheet and metal clinching the second end stile to the elongated flange and the elongated channel of the flush roll-formed steel sheet.
